(19) United States
(12) Patent Application Publication
(10) Pub. No.: US 2006/0243090 A1
(43) Pub. Date: Nov. 2, 2006

(54) Bi-ratio pedal for automotive brake systems

(75) Inventors: Michael C. Carr, Oxford, MI (US); Philipp Weinschrod, Metamora, MI (US)

Correspondence Address: CONTINENTAL TEVES INC.;C/O BRINKS HOFER GILSON & LIONE, P. O. BOX 10395, CHICAGO, IL, 60610, US

(73) Assignee: Continental Teves, Inc.

(21) Appl. No.: 11/455,470

(22) Filed: Jun. 19, 2006

Related U.S. Application Data
(63) Continuation-in-part of application No. 10/445,995, filed on May 27, 2003.

(51) Int. Cl. G05G 1/14

(52) U.S. Cl. 74/560

(57) ABSTRACT

A brake activating mechanism for a vehicle is responsive to the required braking force to adjust the magnification of the manual input force, thereby providing greater assistance to the vehicle operator. The brake activating mechanism generally includes a pedal arm connected to a brake pedal for receiving the manual input force and connected to a pushrod for transmitting the output force. A clutch mechanism is employed that is responsive to the input force to modify the position of the pivot point. In this way, the magnification of the input force via the pedal arm is modified.

### RELATED APPLICATIONS

The present patent application is a continuation-in-part of application Ser. No. 10/445,995 filed May 27, 2003.

### FIELD OF THE INVENTION

The present invention relates generally to a brake activating mechanism for an automotive brake system, and more particularly relates to an activation system providing multiple force transmission ratios.

### BACKGROUND OF THE INVENTION

Automobile braking systems typically include a brake pedal attached to one end of a lever arm while the opposing end of the lever arm is pivotally attached to the vehicle. A pushrod is attached at some point between the opposing ends of the lever arm, i.e., between the brake pedal and the pivotal connection. A manual input force on the brake pedal provided by the vehicle operator results in an output force on the pushrod. The output force is greater than the input force by operation of the lever arm, as is generally understood in the art. Typically, the output force on the pushrod is then transmitted through a brake booster which provides a second magnification of the input force. The force outputted by the brake booster is transmitted to the master cylinder of the braking system, which pressurizes fluid in the brake lines to provide a braking force at the wheels of the vehicle.

Generally, the manual input force needed for proper braking is very slight, primarily due to the force magnification provided by the brake booster as well as the lever arm. However, in failed power conditions or for other reasons, the brake booster may fail to assist in pressurizing the master cylinder. In such a situation, a large amount of manual input force would be required to pressurize the master cylinder and adequately brake the vehicle. Accordingly, there exists a need to provide a brake activating mechanism which can provide additional assistance to the vehicle operator and magnify the manual input force during a failed power condition or when the brake booster is otherwise non-responsive.

### BRIEF SUMMARY OF THE INVENTION

The present invention provides a brake activating mechanism for a vehicle which is responsive to a failed power condition and adjusts the magnification of the manual input force to provide greater assistance to the vehicle operator. The brake activating mechanism generally includes a pedal arm connected to a brake pedal for receiving the manual input force and connected to a pushrod for transmitting the output force. A support bracket is attached to the vehicle, and the pedal arm rotates relative to the support bracket about a pivot point. A clutch is disposed between the pedal arm and the support bracket. The clutch is responsive to the input force to modify the position of the pivot point. In this way, the magnification of the input force via the pedal arm is modified. The present invention is not limited to failed power conditions but can also provide additional assistance in other situations based on setting the clutch to respond to a predetermined manual input force.

According to more specific aspects of the invention, the position of the pivot point is modified relative to both the brake pedal and the pushrod. Preferably, an adapter is disposed between the support bracket and the clutch. The adapter includes a first shaft providing a first pivot point and a second shaft providing a second pivot point. The clutch engages and disengages the adapter to modify the position of the pivot point. More specifically, the pedal arm is pivotally attached to the adapter at the first shaft and the adapter is pivotally attached to the support bracket at the second shaft.

Another embodiment of the brake activating mechanism includes a pedal arm connected to the brake pedal for receiving the manual input force and connected to a pushrod for transmitting the output force. The pedal arm is pivotally attached to the vehicle at a support bracket and rotates relative thereto about one of a first pivot point and a second pivot point. A clutch is operatively attached to the pedal arm and switches between an engaged and disengaged mode based on the level of manual input force. The engaged and disengaged modes each correspond to the pedal arm rotating about one of the first and second pivot points.

Preferably, the clutch is integrally formed in the pedal arm. The pedal arm includes a first portion that is movable relative to a second portion to form the clutch. One portion is connected to the brake pedal while the other portion is connected to the pushrod. An aperture is formed partially by the first portion and partially by the second portion. The side of the aperture is defined by the position of the first portion relative to the second portion. In this way, the aperture frictionally engages and disengages the adapter to form the clutch. The first portion can be selected to be movable relative to the second portion only when the input force which is a predetermined threshold. This threshold can be set to set the shift and pivot points and change and force magnification at any desired level to provide the aforementioned benefits.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a side view of an embodiment of the brake activating mechanism constructed in accordance with the teachings of the present invention;

FIG. 2 is a side view of an adapter forming a portion of the brake activating mechanism;

FIG. 3 is a cross sectional view taken about the line 3-3 of FIG. 1;

FIG. 4 is a side view of another embodiment of the brake activating mechanism constructed in accordance with the teachings of the present invention;

FIG. 5 is a side view of the brake activating mechanism of FIG. 1 having the pedal arm removed;

FIG. 6 is a side view of yet another embodiment of the brake activating mechanism constructed in accordance with the present invention;

FIG. 7 is a side view similar to FIG. 6 showing operation during a low-force condition; and

FIG. 8 is a side view similar to FIG. 6 showing operation during a high-force condition.

### DETAILED DESCRIPTION OF THE INVENTION

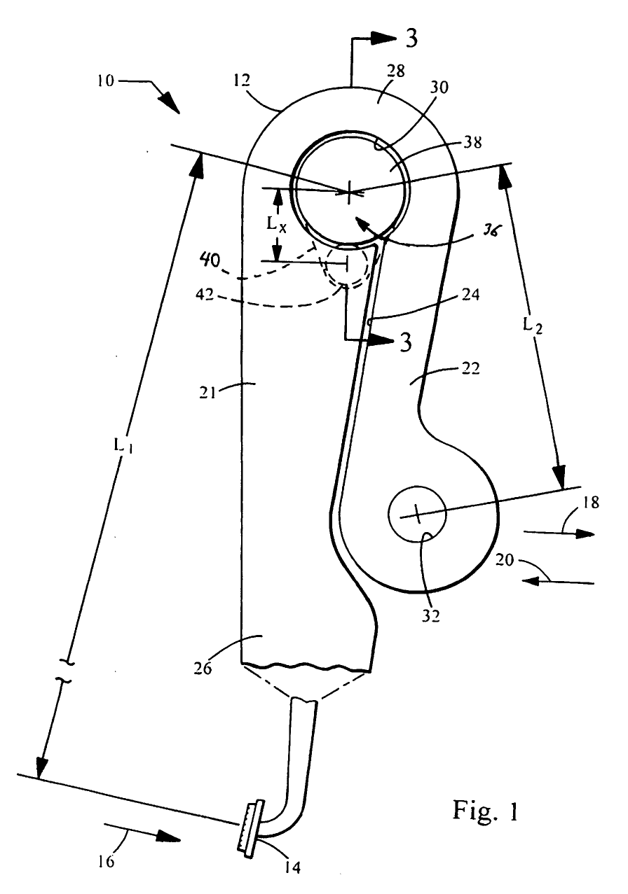

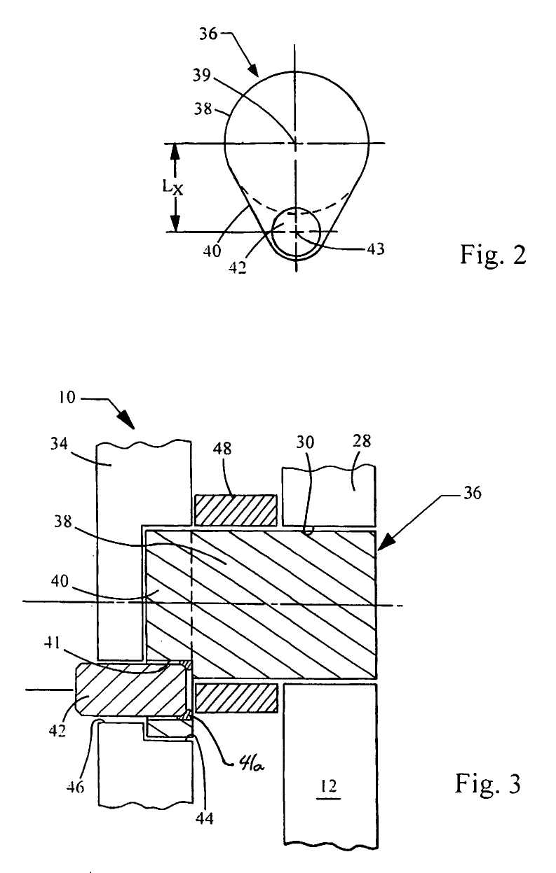

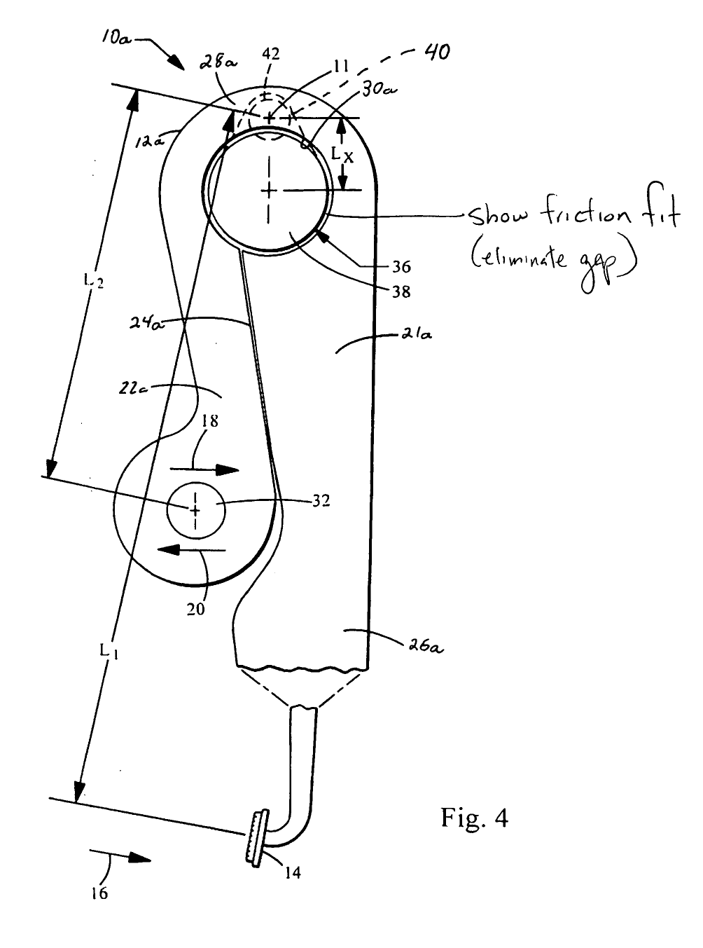

Turning now to the figures, FIGS. 1-3 depict one embodiment of the brake activating mechanism 10 constructed in accordance with the teachings of the present invention. The brake activating mechanism 10 generally includes a pedal arm 12 which is pivotally attached to a vehicle (not shown) by way of an adapter 36 illustrated in more detail in FIG. 2. The adapter 36 is pivotally attached to a bracket 34 as shown in FIG. 3, the bracket 34 being mounted to the vehicle. The pedal arm 12, adapter 36 and bracket 34 are interconnected as best seen in the cross sectional view of FIG. 3.

As shown in FIG. 1, the pedal arm 12 has a brake pedal 14 attached thereto for receiving a manual input force denoted by arrow 16. The pedal arm 12 operates as a lever and magnifies the manual input force 16 to provide an output force as indicated by arrow 18. The output force 18 is transmitted through a pushrod (not shown) usually to a brake booster (not shown) and ultimately the master cylinder (not shown) for pressurizing fluid and providing a braking force to the wheels of the vehicle. As is generally understood, the brake booster and master cylinder provide a reaction force indicated by arrow 20 which is directed opposite to the output force 18.

The pedal arm 12 generally includes a first end 26 that has the brake pedal 14 attached adjacent thereto. An opposing second end 28 of the pedal arm 12 is pivotally attached to the vehicle by way of an aperture 30. As will be discussed in more detail below, the aperture 30 receives a pin 38 of the adapter 36.

The pedal arm 12 is integrally constructed of a first portion 21 and a second portion 22. The first portion 21 provides the first end 26 which has the brake pedal 14. The second portion 22 includes a second aperture 32 structured to receive a clevis pin or other connection member for transmitting the output force 18 to the pushrod and related downstream mechanisms. The first and second portions 21, 22 in combination provide the aperture 30 for pivotally connecting the second end 28 to the vehicle. Stated another way, the pedal arm 12 is provided with a slot 24 that leads to the aperture 30 to define the first portion 21 and the second portion 22.

The first and second portions 21, 22 are separated by the slot 24 which is adjustable in size. That is, the first and second portions 21, 22 are movable relative to each other to modify the size of the slot 24. In this way, the diameter of the aperture 30 is also adjustable. Thus, the size of the aperture 30 is dependent upon the position of the first portion 21 relative to the second portion 22. As discussed further herein, the adjustable aperture 30, dictated by the relative positions of the first and second portions 21, 22, provide a clutch mechanism for modifying the pivot point of the pedal arm 12.

Turning to FIG. 2, the adapter 36 generally comprises a first pin 38 which is connected to a second smaller pin 42 by way of a flange 40. The first pin 38 has a first center point 39 while the second pin 42 has a second center point 43. The first and second center points 39 and 43 are offset by a distance Lₓ which can be selected based on the particular implementation of the present invention. Preferably, the flange 40 includes a chamber 41 which receives the second pin 42 and is physically attached to the pin 42, preferably by welds 41a as shown in FIG. 3. However, in other embodiments the adapter 36 may be formed as a single, unitary component. For example, the adapter 36 may be machined from a single piece of material.

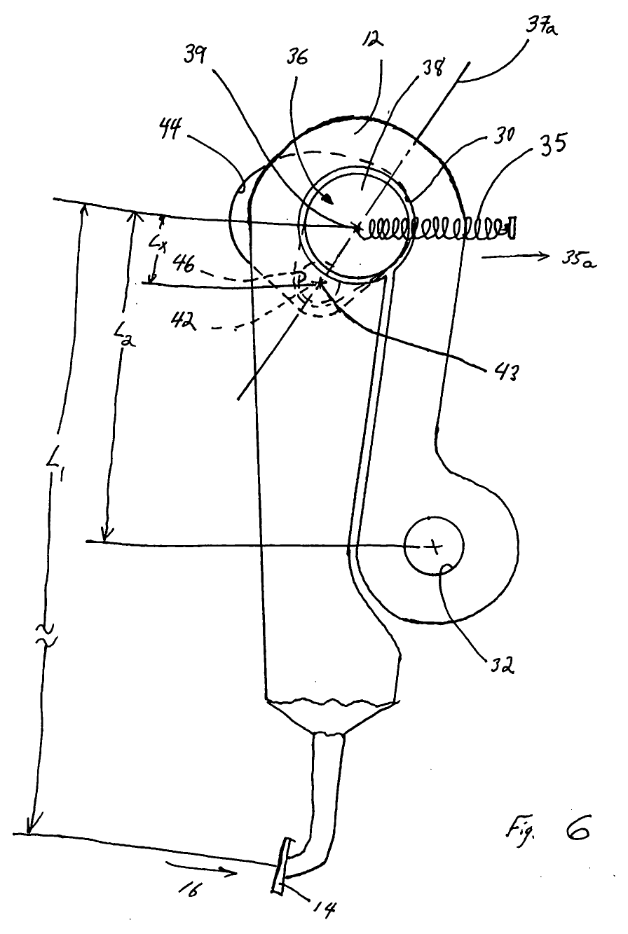

The adapter 36 is pivotally attached to the bracket 34 which is connected to the vehicle (not shown). As shown in the cross sectional view of FIG. 3, the bracket 34 includes a recess 44 that is in communication with a hole 46. The hole 46 is sized larger than the diameter of the second pin 42 for pivotally receiving the second pin 42, i.e. the second pin 42 is permitted to rotate within the hole 46. The hole 46 is preferably round but may be any appropriate shape, for example, square, triangular or oval, to permit the rotation of the second pin 42 as described above. The recess 44 is sized to receive the flange 40 and allow rotation therein. The first pin 38 extends from the flange 40 into the aperture 30 defined in the pedal arm 12 (see FIG. 3). A spacer 48 is provided to distance the pedal arm 12 from the bracket 34 while providing protection to the adapter 36. In FIG. 5, the pedal arm 12 has been removed to show how the recess 44 receives the adapter 36 and how the adapter (including (flange 40) pivot therein. In this example, the adapter 36 is initially aligned forwardly to the right side on the page in the recess 44 as shown by the solid lines and an initial adapter centerline 37a. When the clutch is engaged to grip the first pin 38, and the brake pedal 14 is depressed, the adapter 36 pivots about the second pin 42 within the hole 46 following an arcuate path 45 towards the position shown by the phantom lines and second adapter centerline 37b. It will be recognized that the mechanism may be modified such that the adapter 36 pivots from left to right, or such that the recess 44 is omitted entirely leaving only the hole 46 in the bracket 34.

In operation, the relative movement of the first and second portions 21, 22 of the pedal arm 12 adjust the size of the slot 24 and hence the inner diameter of the aperture 30 to form a clutch mechanism. This clutch mechanism selectively engages or disengages the first pin 38 which is positioned within the adjustable aperture 30. In this way, the pivot point about which the lever arm 12 rotates can be adjusted, and more specifically switched between the first pivot point 39 and the second pivot point 43 defined by the adapter 36 and its first and second pins 38 and 42.

In a first mode of operation, the vehicle operator provides the manual input force 16 on the brake pedal 14 which is transmitted through the pedal arm 12 to the output force 18. When the manual input force 16 is below a predetermined level, denoted herein as a low force condition, the size of the slot 24 and more particularly the aperture 30 remains of a sufficient size to allow the pedal arm 12 to rotate about the first pin 38 at its first pivot point 39. The position of the first pin 38 and adapter 36 are generally indicated by the solid lines in FIG. 5. The distance between the brake pedal 14 and the center point 39 of the first pin 38 is denoted L₁ as shown in FIG. 1. The distance between the point of transmission of the output force 18 (i.e., the center point of aperture 32) and the center point 39 of the first pin 38 is denoted L₂, also shown in FIG. 1. In this low force condition, the magnification of the manual input force 16 is given by the ratio of L₁ over L₂.

However, when the manual input force 16 reaches a predetermined level, and more specifically when the required braking force (i.e., the relation between the input force 16 and the reaction force 20) reaches a predetermined threshold, the size of slot 24 reduces, as does the inner diameter of the aperture 30. That is, the inner diameter 30 is sized and structured such that it reaches a size where the inner surface of the aperture 30 frictionally engages the outer surface of the first pin 38. When the pedal arm 12 has clamped onto the first pin 38 via this clutch mechanism, the pedal arm 12 and adapter 36 rotate in unison. In this way, the pedal arm 12 and adapter 36 rotate together relative to the vehicle about the second center point 43 of the second pin 42 which rotates within the hole 46 as described above as shown by the dotted lines in FIG. 5.

Accordingly, in this second mode of operation, referred to herein as a high force condition, the pivot point of the lever arm 12 has moved a distance Lₓ from the first center point 39 to the second center point 43. As a result, the magnification of the manual input force 16 has been changed, as the ratio of L₁ to L₂ has changed. More specifically, L₁ is now defined by the second pivot point 43, and thus has been shortened by the distance Lₓ. Likewise, the distance L₂ has also been shortened by the distance Lₓ.

A specific dimensional example will be given to aid the understanding of the present invention. With reference to FIG. 1, assume the distance L₁ is 415 mm, while the distance L₂ is 90 mm. In this scenario, during a low force condition, the ratio of L₁ to L₂ equals 415/90, which equals 4.61:1. However, during a high force condition (500 N for example), both L₁ and L₂ are modified by the distance Lₓ as the pivot point changes from center point 39 to center point 43. Assuming the distance Lₓ is 20 millimeters, L₁ now becomes 395 millimeters while L₂ becomes 70 millimeters. In this scenario, the ratio becomes 395/70, which equals 5.64:1. Accordingly, depending on the operating conditions and the input force 16 actuating the brake, the magnification provided by the pedal arm 12 can be either 4.61:1 or 5.64:1 (the latter being the high force or emergency condition).

It can therefore be seen that the simple clutch mechanism defined by the adjustable aperture 30 and the first and second portions 21 and 22 of the lever arm, allows the adapter 36 to be used to provide first and second center points which differ by a predetermined distance. In this way, the pedal arm 12 can be constructed to respond to a predetermined manual input force 16, and more specifically to a required braking force, dependent upon the reaction force 20. Based on the material of the pedal arm 12 (preferably a metal) and the size and structure of the slot 24 and aperture 30, the manual force 16 provides the engagement and disengagement of the clutch mechanism.

One particular application of this brake activating mechanism 10 would be as a backup system for the brake booster. In a no power condition or if the brake booster were to otherwise fail, a significantly higher manual input force 16 would be required to brake the vehicle. In this situation, the predetermined force level could be such that the clutch mechanism engages, and particularly the pedal arm 12 would frictionally engage the adapter 36 about the first pin 38, requiring the pedal arm 12 to pivot relative to the vehicle about the second pin 42. In this way, the magnification of force provided by the pedal arm 12 would be increased in order to provide additional assistance to the vehicle operator.

It will be recognized that the present invention can be employed for other purposes or in other situations, simply by adjusting the predetermined force at which the pivot point shifts. For example, the feel and responsiveness of the brake pedal can be adjust during normal operation by setting the predetermined force within the normal range of operation (e.g. between 0-500 N). The predetermined force could also be adjusted based on the vehicle dynamics, such as vehicle loading conditions. Other types of activating mechanisms may also employ the present invention, such as those having the pivot point located between the ends of the pedal arm, i.e. between the brake pedal and the pushrod connection point.

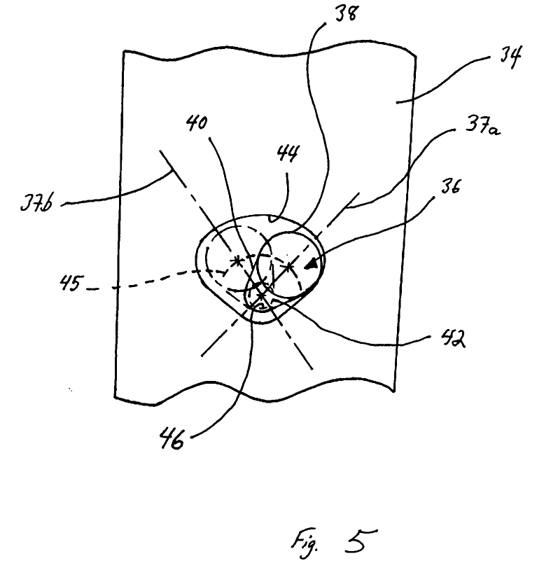

It will also be recognized by those skilled in the art that various other clutch mechanisms can be designed to respond to the manual input force 16 and specifically the required braking force. Likewise, the adapter 36 could be eliminated or integrally formed into either the pedal arm 12 or the vehicle. For example, FIG. 4 depicts an alternate embodiment of a brake activating mechanism 10a constructed in accordance with the present invention. The operation of the mechanism 10a is substantially similar to the previously described mechanism 10, and like parts have been given like numerals. In this embodiment, the clutch has been designed to be normally engaged, rather than normally disengaged as in the prior embodiment.

The pedal arm 12a generally includes a first portion 21a that is movable relative to a second portion 22a. The first and second portions 21a and 22a define an adjustable aperture 30a in combination. The first portion 21a is connected again to the brake pedal 14 for receiving the manual input force 16. The second portion 22a is connected via aperture 32 to a pushrod, brake booster, and master cylinder for transmitting an output force 18 and receiving the reaction force 20. A slot 24a is defined between the first and second portions 21a and 22a and its size in its normal condition is very small.

Again, the first end 26a of the pedal arm 12a is attached to the brake pedal 14, while the second end 28a is pivotally attached to the vehicle. The adapter 36 is identically structured to the adapter shown in FIG. 2, although it is attached to the vehicle and its bracket 34 in a different manner. More specifically, the second pin 42 is pivotally attached to a recess 46 in the bracket 34 at a position above the recess 44 and the first pin 38. In this way, the pedal arm 12a is normally engaged with the first pin 38 and rotates in conjunction with the adapter 36. Accordingly, in the first mode corresponding to a low force condition, the pedal arm 12a and the adapter 36 rotate relative to the vehicle and its bracket 34 about second pin 42 and its center or pivot point 43. However, when the manual input force 16 reaches a predetermined level, (and/or the required braking force based on the reaction force 20) the first and second portions 21a and 22a begin to separate thereby enlarging the slot 24. At the same time, the inner diameter of the aperture 30a increases such that the clutch disengages the second pin 38. With the clutch disengaged (i.e., the inner diameter of the aperture 30a not frictionally engaging the outer diameter of the pin 38) the pedal arm 12a is free to rotate about the second pin 38 and its center or pivot point 39. As the pivot points 39, 43 are again separated by a distance Lₓ, the distances L₁ and L₂ are shortened by the distance Lₓ. In this way, the magnification of the manual input force 16 can be modified as in the prior embodiment.

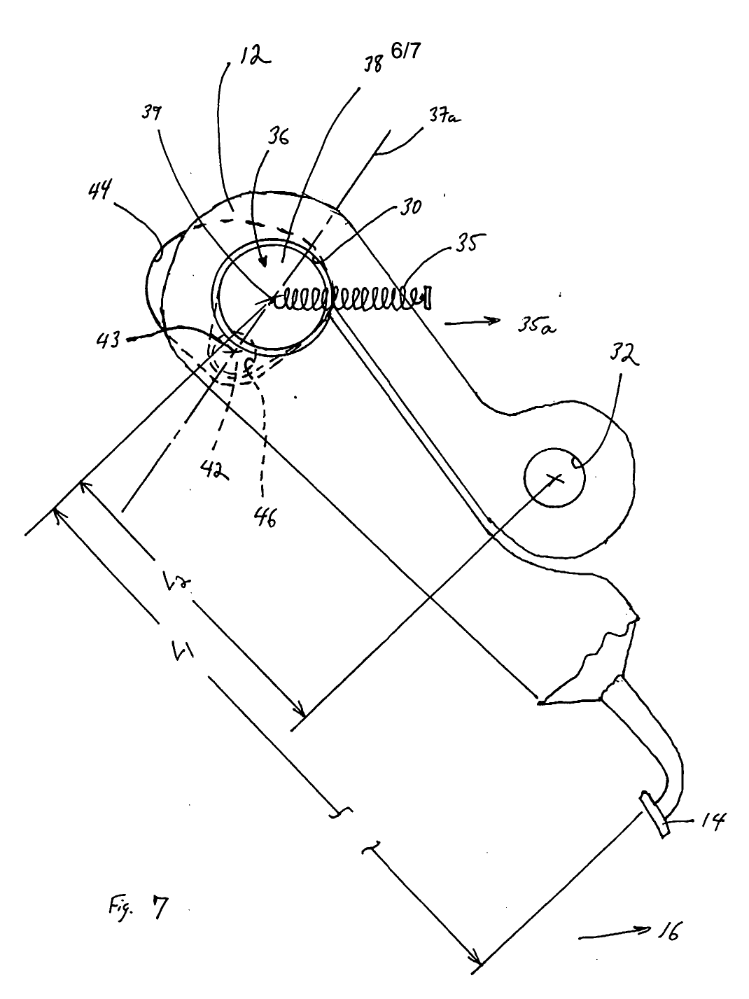

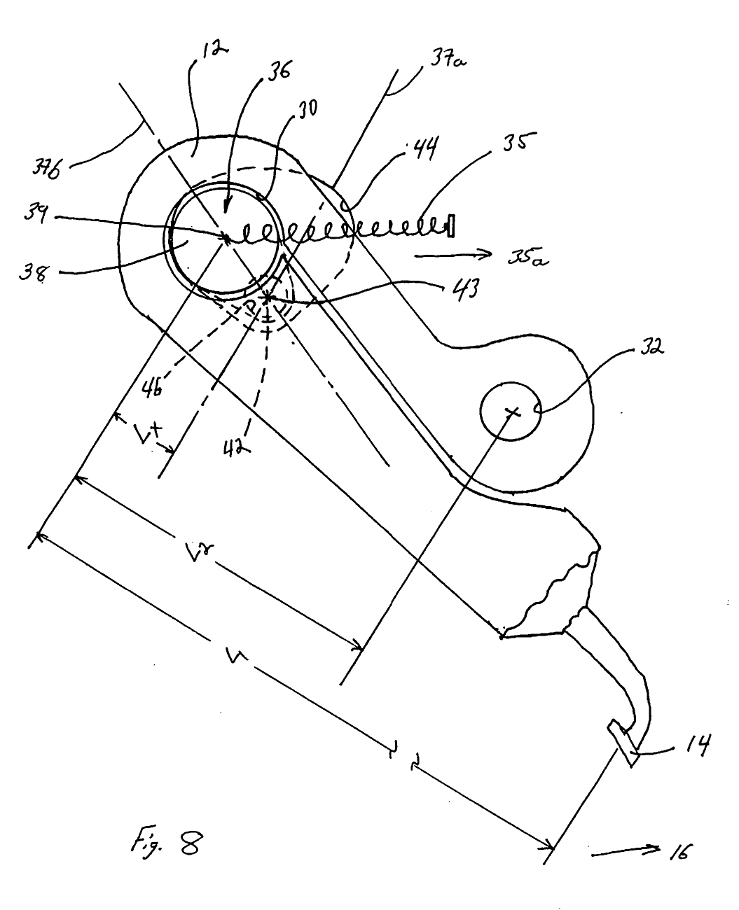

A third embodiment, similar to the embodiment of FIGS. 1-3, is illustrated in FIG. 6-8 (like numbers for like parts have been used for clarity). These figures show the positions of the pedal arm 12 and adapter 36 as they move relative to the recess 44 between a low-force condition (normal operating condition) and high-force condition (emergency condition). Turning first to FIG. 6, the normal condition is shown and, in this embodiment, includes a tension spring 35 providing a bias force acting in the direction of the arrow 35a on the adapter 36. The tension spring 35 is sized to provide only a small biasing force to assist with maintaining the adapter 36 in a position on the right side of the recess 44 and ensure a smooth transition between the low-force and high-force conditions shown in FIGS. 7 and 8 respectively. While a tension spring is shown, other springs such as, for example, compression springs, leaf springs, or torsion springs, may also be used depending on the structures and requirements of each application.

In FIG. 6 the aperture 30 forming the clutch mechanism described is disengaged. However, when a low force is applied, as shown by arrow 16 in FIG. 7, the pedal arm 12 pivots about the first pin 38 while the adapter 36 stays in the initial position within the recess 44. Here the magnification of force by the pedal arm 12 is given by the ratio L₁ over L₂. When a high force 16 is applied, as shown in FIG. 8, the clutch mechanism clamps the first pin 38 and the pedal arm 12 and adapter 36 functionally becomes a single unit, pivoting about the second center point 43 of the second pin 42 of the adapter 36. As a result, the adapter moves within the recess 44 to the position shown in FIG. 8 and indicated by the centerline 37b. Here the magnification of force by the pedal arm is given by the ratio (L₁-Lₓ) over (L₂-Lₓ). When the high force 16 is removed, the bias force 35a of the spring 35 assists the adapter 36 in returning to the initial position of FIG. 6.

Accordingly, the present invention provides a simple and automatic structure and method for increasing the magnification of the manual input force on a brake pedal. Such a mechanism finds many uses, especially for providing increased magnification of the input force when the vehicles brake booster has failed or is without power. The brake activating mechanism automatically makes these changes when necessary. The actual force needed to open the slot 24 and 24a to engage or disengage the clutch (formed in part by the adjustable aperture 30 and 30a) may be designed to any requirement. The disclosed clutch being formed by a slotted pedal arm is a simple and expedient design, although the present invention should not be so limited. Numerous modifications to the pedal arm and the clutch mechanism can be readily envisioned, as numerous clutch mechanisms are well known throughout the art. Likewise, the clutch mechanism may engage or disengage when reaching the predetermined force, as shown in the different embodiments described above.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A brake activating mechanism for a vehicle, the mechanism receiving a manual input force from a vehicle operator, the mechanism providing an output force in response to the input force, the mechanism comprising:
a pedal arm connected to a brake pedal for receiving the manual input force, the pedal arm connected to a pushrod for transmitting the output force;
a support bracket attached to the vehicle, the pedal arm rotating relative to the support bracket about a pivot point;
a clutch disposed between the pedal arm and the support bracket, the clutch responsive to the input force to modify the position of the pivot point.

2. The brake activating mechanism of claim 1, wherein the position of the pivot point is modified relative to the brake pedal.

3. The brake activating mechanism of claim 1, wherein the position of the pivot point is modified relative to the pushrod.

4. The brake activating mechanism of claim 1, further comprising an adapter disposed between the support bracket and the clutch, the adapter including a first shaft providing a first pivot point and a second shaft providing a second pivot point.

5. The brake activating mechanism of claim 4, wherein the clutch engages and disengages the adapter to modify the position of the pivot point.

6. The brake activating mechanism of claim 5, wherein the clutch engages and disengages the first shaft.

7. The brake activating mechanism of claim 6, wherein the pedal arm rotates about the first shaft when the clutch is disengaged.

8. The brake activating mechanism of claim 4, wherein a spring is operatively attached to the adapter to bias the adapter to an initial position.

9. A brake activating mechanism for a vehicle, the mechanism receiving a manual input force from a vehicle operator, the mechanism providing an output force in response to the input force, the mechanism comprising:
a pedal arm connected to a brake pedal for receiving the manual input force, the pedal arm connected to a pushrod for transmitting the output force;
the pedal arm being pivotally attached to the vehicle at a support bracket, the pedal arm rotating relative to the support bracket about one of a first pivot point and a second pivot point; and
a clutch operatively attached to the pedal arm, the clutch switching between an engaged and a disengaged mode based on the level of the manual input force, the engaged and disengaged modes each corresponding to the pedal arm rotating about one of the first and second pivot points.

10. The brake activating mechanism of claim 9, wherein the clutch is integrally formed in the pedal arm.

11. The brake activating mechanism of claim 9, wherein the pedal arm includes a first portion moveable relative to a second portion to form the clutch.

12. The brake activating mechanism of claim 11, wherein the first portion is connected to the brake pedal and the second portion is connected to the pushrod.

13. The brake activating mechanism of claim 11, wherein the pedal arm includes an aperture formed in part by the first portion and in part by the second portion, the size of the aperture defined by the position of the first portion relative to the second portion.

14. The brake activating mechanism of claim 13, wherein the aperture frictionally engages and disengages the adapter to form the clutch.

15. The brake activating mechanism of claim 9, wherein the first portion is movable relative to the second portion only when the input force reaches a predetermined threshold.

16. A pedal arm for a brake activating mechanism having a brake pedal and a pushrod, the brake pedal for receiving a manual input force from a vehicle operator, the pushrod for transmitting an output force in response to the input force, the pedal arm comprising:
a first end connected to the brake pedal;
a second end pivotally connected to the vehicle at two points including a first point and a second point;
the pedal arm being connected to the pushrod at a point between the first and second ends; and
the pedal arm pivoting about the first point in response to a first input force, the pedal arm pivoting about the second point in response to a second input force, the second input force being higher than the first input force.

17. The pedal arm of claim 16, wherein the pedal arm further includes a clutch responsive to the manual input force.

18. The pedal arm of claim 17, wherein the pedal arm includes a first portion moveable relative to a second portion to form the clutch.

19. The pedal arm of claim 18, wherein the first portion is connected to the brake pedal and the second portion is connected to the pushrod.

20. The pedal arm of claim 18, wherein the pedal arm includes an aperture formed in part by the first portion and in part by the second portion, the size of the aperture defined by the position of the first portion relative to the second portion.

21. The pedal arm of claim 17, wherein the vehicle includes an adapter pivotally attached to the vehicle at the second point, and wherein the pedal is pivotally attached to the adapter at the first point, the clutch engaging and disengaging the adapter whereby the pedal arm pivots about one of the first and second points.

22. The brake activating mechanism of claim 21, wherein a spring is operatively attached to the adapter to bias the adapter to an initial position.

23. A brake activating mechanism for a vehicle, the mechanism receiving a manual input force from a vehicle operator, the mechanism providing an output force in response to the input force, the mechanism comprising:
a support bracket attached to the vehicle;
an adapter pivotally attached to the support bracket at a first pivot point;
a pedal arm having a first end and a second end, the first end being attached to a brake pedal for receiving the input force, the second end being pivotally attached to the adapter at a second pivot point; and
the pedal arm operable in two modes including a first mode wherein the pedal arm pivots about the first pivot point, and a second mode wherein the pedal arm pivots about the second pivot point.

24. The brake activating mechanism of claim 23, wherein the first and second pivot points are spaced different distances from the brake pedal.

25. The brake activating mechanism of claim 23, further comprising a clutch disposed between the pedal arm and the adapter, the clutch engaging and disengaging the adapter and the pedal arm to switch between the first and second modes.

26. The brake activating mechanism of claim 23, wherein the adapter includes a first shaft providing a first pivot point and a second shaft providing a second pivot point.
